(19) United States
(12) Patent Application Publication
(10) Pub. No.: US 2026/0049260 A1
(43) Pub. Date: Feb. 19, 2026

(54) MOBILITY ENHANCER USEFUL IN MANUFACTURING CONTAINERS

(71) Applicant: Henkel AG & Co. KGaA, Duesseldorf (DE)

(72) Inventors: Patricia Christine Tucker, Lambertville, MI (US); Zackary Dean Firestone, Tallahassee, FL (US); Bruce H. Goodreau, Romeo, MI (US)

(21) Appl. No.: 19/371,303

(22) Filed: Oct. 28, 2025

Related U.S. Application Data
(63) Continuation of application No. PCT/US2024/028719, filed on May 10, 2024.
(60) Provisional application No. 63/501,223, filed on May 10, 2023.

(51) Int. Cl. C10M 173/02; B65D 25/14; B65D 25/34; C10M 107/34; C10M 135/36; C10M 145/34; C10M 161/00; C10M 169/04; C10M 177/00; C10N 30/04; C10N 30/16; C10N 40/20; C10N 50/02; C10N 70/00

(52) U.S. Cl. CPC C10M 173/02; B65D 25/14; B65D 25/34; C10M 107/34; C10M 135/36; C10M 145/34; C10M 161/00; C10M 169/044; C10M 177/00; C10M 2201/02; C10M 2209/1045; C10M 2209/107; C10M 2219/104; C10N 2030/04; C10N 2030/16; C10N 2040/20; C10N 2050/02; C10N 2070/02

(57) ABSTRACT

Provided herein are aqueous mobility enhancing compositions for improving travel of metal containers through a manufacturing process, including manufacturing equipment and conveyors; methods for making such compositions, and methods for reducing a coefficient of friction on a surface of a metal container by contacting the container with a disclosed composition and containers having a metal surface having a composition of the invention dried-in-place thereon. The compositions are useful for producing desirable slip angle characteristics on surfaces of metal containers that have been subjected only to cleaning processes, or that have been both cleaned and conversion coated.

### TECHNICAL FIELD

The present disclosure pertains to compositions and methods for improving travel of metal containers through a manufacturing process, more particularly reducing friction between containers contacting each other and equipment in moving along a processing line.

### BACKGROUND

Aluminum cans are commonly used as containers for a wide variety of products. After their manufacture, aluminum cans are typically washed with acidic cleaners and rinsed to remove any residual cleaners and prepare the cans for lacquering and decorating. The last stage in the aluminum can pre-treatment process is the application of a mobility enhancer that is compatible with lacquer adhesion and drying it in place. Optionally, a reactive conversion coating composition may be applied to modify the metal surface prior to application of a mobility enhancer that is compatible with both the conversion coating, lacquers and inks. An important consideration in modifying can surface properties with mobility enhancers is the effect on printing, labeling and lacquers sprayed on cans' inside surface.

Mobility enhancers are a necessary part of a pretreatment process for metal containers because they provide a reduction in the coefficient of friction as the containers progress through the manufacturing process, for example, through a conveyor system, track work and decorator, interior coating (IC) spray, and necker/flanger. Containers may travel through process stages at speeds in a range of as slow as 1 can/second to about 2000 cans/min. Without the use of mobility enhancers, container jams and line stoppages can occur. In theory, a chemical that provides a reduction in the coefficient of friction of a metal surface and meets FDA regulations might possibly be considered acceptable as a mobility agent, but other performance criteria must be met for usefulness. For example, additional challenges are presented when a conversion coating has been applied prior to the application of a mobility agent. This is at least because the conversion coating can result in a significant increase in surface roughness, which can serve to impede the use of certain mobility enhancers, such as those that only include surfactants.

Previously mobility enhancers were composed mainly of surfactants selected from phosphate esters; alcohols; fatty acid including mono-, di-, tri-, and poly-acids, and fatty acid derivatives such as salts; hydroxy acids, amides, esters, ethers and derivatives thereof; and mixtures thereof. Drawbacks of compositions containing phosphates, their esters and/or phosphoric acid include environmental concerns and waste treatment needs. Despite adequate performance in some applications, with increasing processing line speeds desired by container manufacturers, there is a need for improvements to slip (i.e. reduction coefficient of friction) for aluminum can processing, particularly when applied to conversion coated aluminum cans. Those conversion coatings result in high surface roughness and thus a higher coefficient of friction that is similar to that of a can that has only been etched by using a fluoride based cleaner. It is desirable to improve slip angle performance compared to existing mobility enhancers, particularly in reduction in coefficient of friction to support moving cans at high speed used in commercial can plants throughout the track work in the remainder of the can decorating, lacquering, and forming processes.

One drawback of some surfactant only based mobility enhancing compositions is excess foam generation in the working bath. Results of high volume and/or persistent foam in a mobility enhancing composition include foam overflow from the bath or sump as well as subsequent drag-out of material from the processing line into the oven. This can cause both increased consumption of chemicals and safety and environmental concerns, e.g. possible foam leaking out of access chambers and onto floors increases risk of slip and fall events and of environmental exposure to processing chemicals. Furthermore, overfoaming can increase equipment costs such as the need for spray risers to reduce the foam.t

Waxes have also been used as mobility enhancers, but improvements in wetting of exterior surfaces during decoration and solubility characteristics of these products are desirable. Waxes can also have the drawback of inclusions of silane- or siloxane-based materials, and a tendency to create emulsions in some applications.

In addition to the challenges listed above, the use of Bisphenol-A non-intent (BPANI) lacquers, meaning no Bisphenol-A is intentionally added to the lacquer, is becoming more prevalent due to regulations regarding the use of epoxy-based materials, such as Bisphenol-A. Some can processors spray mobility enhancing compositions on the interior of metal containers during processing in order to ease loading and unloading of containers on and off the decorator equipment. Some BPANI lacquers tend to be more porous than conventional epoxy-based lacquers, showing higher metal exposure values in enamel rating tests. Even though containers are baked after decoration and after lacquering, a potential exists for indirect contact between products for human consumption and traces of the mobility enhancer material. Thus, a preference for non-epoxy lacquers presents an additional need for mobility enhancers meeting safety standards for indirect contact described above.

### SUMMARY

It is an object of the invention to solve one or more of the above-described disadvantages. The present invention relates to an aqueous mobility enhancing composition; a dried-in-place mobility enhancing composition adhered to a metal surface; a container, preferably a food or beverage container, having a metal surface comprising a layer of dried-in-place mobility enhancer deposited thereon, optionally comprising a cured lacquer layer deposited after the aqueous mobility enhancing composition is applied and dried; and independently optionally comprising a conversion coating layer disposed on the metal surface underlying the dried-in-place mobility enhancer. Embodiments of the invention may exhibit one or more of excellent adhesion to aluminum; a mobility enhancer coated container having lower coefficient of friction than a comparable container lacking the mobility enhancer, improved travel through conveyor systems; and a product, component or assembly made with the inventive composition or comprising the dried-in-place composition, methods of making and using the foregoing.

Provided herein are aqueous mobility enhancing compositions useful in improving travel of metal containers through a manufacturing process, in particular high-speed travel through equipment and conveyor systems, the composition comprising polyethylene glycol (PEG) having a molecular weight of about 200 to about 15,000 Dalton, a surfactant component, and optionally a biocidal agent.

Also disclosed herein are concentrates that are useful in forming an aqueous mobility enhancing composition by dilution with water, the concentrate comprising polyethylene glycol (PEG) having a molecular weight of about 200 to about 15,000 Dalton, a surfactant component, and optionally a biocidal agent. The present disclosure also provides methods for making an aqueous mobility enhancing composition for reducing a coefficient of friction of a surface of a metal container comprising mixing the concentrate with an aqueous diluent.

The present disclosure also provides methods for reducing a coefficient of friction of a surface of a metal container, the method comprising contacting the surface of the metal container with an aqueous mobility enhancing composition according to the present disclosure, followed by drying the composition in place to form a mobility enhancer, preferably a layer of mobility enhancer. In some embodiments, excess mobility enhancing composition may be permitted to drain from container surfaces prior to drying. Optionally, in some embodiments, over sprayed and/or excess drained mobility enhancing composition may be re-circulated and/or certain components recycled by know methods. Also provided are metal containers comprising a surface having a coefficient of friction that has been reduced using such methods.

Further disclosed are metal containers comprising a surface that has been contacted with an aqueous mobility enhancing composition according to the present disclosure as well as metal containers having a dried-in-place layer of the mobility enhancer on a surface of the metal. In some embodiments, the metal container surface comprises a conversion coating layer disposed between the metal surface and the dried-in-place mobility enhancer, e.g. conversion coating deposited on metal surface and the dried-in-place mobility enhancer adhered to the conversion coating. In some embodiments, the metal container surface comprises dried-in-place mobility enhancer adhered to the metal surface and a layer of lacquer, preferably a BPANI lacquer.

The present disclosure also provides methods for processing a metal container comprising guiding the metal container through a manufacturing process line, wherein the metal container comprises a surface that has been contacted with an aqueous mobility enhancing composition according to any disclosed embodiment, preferably comprising a surface having deposited thereon a dried-in-place mobility enhancer based on the aqueous mobility enhancing composition described herein.

Also provided are methods for processing a metal container comprising guiding the metal container through a manufacturing process, wherein the metal container comprises a surface having a coefficient of friction that has been reduced using a presently disclosed method.

The present disclosure also provides coatings on a metal surface comprising a mobility enhancer that is formed by contacting the surface with an aqueous mobility enhancing composition according to any presently disclosed embodiment and drying the composition on the container. The disclosures of each patent, patent application, and publication cited or described in this document are hereby incorporated herein by reference, in their entirety.

Various Embodiments of the invention are described throughout this disclosure, including:

Embodiment 1: An aqueous mobility enhancing composition useful in improving travel of metal containers through a manufacturing process, the composition comprising: polyethylene glycol (PEG) having a molecular weight of about 200 to about 15,000 Daltons; a surfactant component; and optionally a biocidal agent.

Embodiment 2: The aqueous mobility enhancing composition according to Embodiment 1, wherein the PEG has a molecular weight of about 5,000 to about 10,000 Dalton.

Embodiment 3: The aqueous mobility enhancing composition according to Embodiment 1 or Embodiment 2, wherein the PEG has a molecular weight of about 7,000 to about 9,000 Dalton.

Embodiment 4: The aqueous mobility enhancing composition according to any preceding Embodiment, wherein the PEG is present in an amount of about 1,500 ppm up to the solubility limit of the PEG in the composition.

Embodiment 5: The aqueous mobility enhancing composition according to any preceding Embodiment, wherein the PEG is present in an amount of about 1,500 ppm up to about 8,000 ppm.

Embodiment 6: The aqueous mobility enhancing composition according to any preceding Embodiment, wherein the PEG is present in an amount of about 1,500 ppm up to about 6,000 ppm.

Embodiment 7: The aqueous mobility enhancing composition according to any preceding Embodiment wherein the surfactant component comprises a first ethylene glycol-polyalkylene oxide copolymer and a second ethylene glycol-polyalkylene oxide copolymer different from the first ethylene glycol polyalkylene oxide copolymer; wherein the first ethylene glycol-polyalkylene oxide copolymer is present in an amount of about 15 ppm up to the solubility limit of the first ethylene glycol-polyalkylene oxide copolymer in the composition; and the second ethylene glycol-polyalkylene oxide copolymer is present in an amount of about 1 ppm up to the solubility limit of the second ethylene glycol-polyalkylene oxide copolymer in the composition, and wherein the PEG is present in an amount of about 1,500 ppm up to 5,000 ppm.

Embodiment 8: The aqueous mobility enhancing composition according to Embodiment 7 wherein the first ethylene glycol-polyalkylene oxide copolymer comprises a copolymer of propylene oxide and ethylene oxide, preferably a random copolymer, a block copolymer, an ethylene oxide end-capped copolymer or a combination thereof.

Embodiment 9: The aqueous mobility enhancing composition according to Embodiment 7 wherein the first ethylene glycol-polyalkylene oxide copolymer comprises a triblock copolymer of polyethylene oxide, polypropylene oxide, and polyethylene oxide; and has a molecular weight of about 5,000 to 10,000 Dalton.

Embodiment 10: The aqueous mobility enhancing composition according to any one of Embodiments 7-9, wherein the first ethylene glycol-polyalkylene oxide copolymer is present in an amount of about 14 ppm up to the solubility limit of the first ethylene glycol-polyalkylene oxide copolymer in the composition.

Embodiment 11: The aqueous mobility enhancing composition according to any one of Embodiments 7-10, wherein the first ethylene glycol-polyalkylene oxide copolymer is present in an amount of about 14 ppm to about 100 ppm, preferably from about 16 ppm to about 80 ppm.

Embodiment 12: The aqueous mobility enhancing composition according to any one of Embodiments 7-11, wherein the second ethylene glycol-polyalkylene oxide copolymer comprises a copolymer of propylene oxide and ethylene oxide, preferably a random copolymer, a block copolymer, an ethylene oxide end-capped copolymer or a combination thereof and has a molecular weight of about 1,500 to 3,500 Dalton.

Embodiment 13: The aqueous mobility enhancing composition according to Embodiment 7 wherein the second ethylene glycol-polyalkylene oxide copolymer comprises a difunctional block copolymer surfactant comprising about 10 to 30 wt. % ethylene oxide and terminating in primary hydroxyl groups.

Embodiment 14: The aqueous mobility enhancing composition according to any one of Embodiments 7-13, wherein the second ethylene glycol-polyalkylene oxide copolymer is present in an amount of about 1 ppm up to the solubility limit of the second ethylene glycol-polyalkylene oxide copolymer in the composition.

Embodiment 15: The aqueous mobility enhancing composition according to any one of Embodiments 7-13, wherein the second ethylene glycol-polyethylene oxide copolymer is present in an amount of about 1 ppm up to about 30 ppm, preferably from about 2 ppm up to about 10 ppm.

Embodiment 16: The aqueous mobility enhancing composition according to any one of Embodiments 7-13, wherein the ratio of the first and second ethylene glycol-polyalkylene oxide copolymers is in a range of about 2:1 to about 0.75:1, desirably about 1.5:1 to 1:1 preferably about 1.3:1 to 1.1:1.

Embodiment 17: The aqueous mobility enhancing composition according to any preceding Embodiment, wherein the biocidal agent comprises 2-Methyl-4-isothiazolin-3-one.

Embodiment 18: A concentrate useful in forming an aqueous mobility enhancing composition by dilution with water, the concentrate comprising: polyethylene glycol (PEG) having a molecular weight of about 200 to about 15,000 Dalton; a surfactant; and optionally a biocidal agent.

Embodiment 19: The concentrate according to Embodiment 18, wherein total surfactant is present in a ratio to total PEG of 5 pbw:100 pbw-15 pbw:100 pbw.

Embodiment 20: A method for making an aqueous mobility enhancing composition for reducing a coefficient of friction of a surface of a metal container comprising mixing the concentrate according to Embodiment 18 with an aqueous diluent.

Embodiment 21: The method according to Embodiment 20, wherein the concentrate is added to the aqueous bath in an amount of about 2 g to 7 g per liter of the aqueous bath.

Embodiment 22: A method for reducing a coefficient of friction of a surface of a metal container, the method comprising: contacting, preferably immersing, more preferably spraying the surface of a metal container with an aqueous mobility enhancing composition according to any one of Embodiments 1-17; and drying the composition in place.

Embodiment 23: The method according to Embodiment 22, further comprising applying a conversion coating to the surface of the metal container prior to contacting the metal container in the aqueous mobility enhancing composition.

Embodiment 24: The method according to Embodiment 22 or Embodiment 23, wherein the surface of the metal container has a slip angle of 30° or lower after drying.

Embodiment 25: A metal container comprising a surface that has been contacted in an aqueous mobility enhancing composition according to any one of Embodiments 1-17.

Embodiment 26: The metal container according to Embodiment 25, wherein the surface of the metal container has a slip angle of 30° or lower following the contacting step.

Embodiment 27: A metal container comprising a surface having a coefficient of friction that has been reduced using the method according to Embodiment 22 or Embodiment 23.

Embodiment 28: The metal container according to Embodiment 27, wherein the surface of the metal container has a slip angle of 30° or lower following the contacting step.

Embodiment 29: A method for processing a metal container comprising guiding the metal container through a manufacturing process, wherein the metal container comprises a surface that has been contacted with an aqueous mobility enhancing composition according to any one of Embodiments 1-17.

Embodiment 30: A method for processing a metal container comprising guiding the metal container through a manufacturing process, wherein the metal container comprises a surface having a coefficient of friction that has been reduced using the method according to Embodiment 22 or Embodiment 23.

Embodiment 31: A coating on a metal surface comprising a mobility enhancer that is formed by contacting the surface with an aqueous mobility enhancing composition according to any one of Embodiments 1-17 and drying the composition on the container.

Embodiment 32: The coating according to Embodiment 31, further comprising a conversion coating layer interposed between the metal surface and the mobility enhancer.

As employed above and throughout the disclosure, the following terms and abbreviations, unless otherwise indicated, shall be understood to have the following meanings.

In this disclosure, the terms “container” and “can” are used interchangeably, generally referring to a hollow receptacle for holding goods, typically formed partially or entirely from metal (e.g. sheet metal), and having a removable closure sealed against leakage of contents. More specifically, containers/cans for food and/or beverages are commonly known having been sold at grocers' for more than 100 years, and there is still potential for improvement in processing containers in high-speed processing lines.

Throughout the description, unless expressly stated to the contrary: temperatures are expressed in degrees Celsius; percent, “parts of”, and ratio values are by weight or mass; molecular weight (MW) is weight average molecular weight unless otherwise specified; the word “mole” means “gram mole”, and the word itself and all of its grammatical variations may be used for any chemical species defined by all of the types and numbers of atoms present in it, irrespective of whether the species is ionic, neutral, unstable, hypothetical or in fact a stable neutral substance with well-defined molecules.

In the present disclosure the singular forms “a”, “an”, and “the” include the plural reference, and reference to a particular numerical value includes at least that particular value, unless the context clearly indicates otherwise. Thus, for example, a reference to “a compound” is a reference to one or more of such compounds and equivalents thereof known to those skilled in the art, and so forth. Furthermore, when indicating that a certain chemical moiety “may be” X, Y, or Z, it is not necessarily intended by such usage to exclude other choices for the moiety; for example, a statement to the effect that a moiety “may be alkyl, aryl, or amino” does not necessarily exclude other choices for the moiety, such as halo, aralkyl, and the like.

Other than in the operating examples, or where otherwise indicated, all numbers expressing quantities of ingredients, reaction conditions, or defining ingredient parameters used herein are to be understood as modified in all instances by the term “about”. When values are expressed as approximations, by use of the antecedent “about,” it will be understood that the particular value forms another embodiment. As used herein, “about X” (where X is a numerical value) preferably refers to ±10% of the recited value, inclusive. Also, when the term “about” precedes a range, it is understood that the term modifies both recited endpoints and all points embraced within the range. For example, the phrase “about 1-10” is understood to mean “about 1 to about 10”, as well as “about x”, wherein x refers to any value between 1 and 10. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” In another example, when a listing of possible choices for a moiety including “hydrogen, alkyl, and aryl” is provided, the recited listing may be construed as including situations whereby any of “hydrogen, alkyl, and aryl” is negatively excluded; thus, a recitation of “hydrogen, alkyl, and aryl” may be construed as “hydrogen and aryl, but not alkyl”, or simply “wherein the moiety is not alkyl”.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

The transitional terms “comprising,” “consisting essentially of,” and “consisting of” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

For a variety of reasons, it is preferred that inventions (e.g. compositions and, dried-in-place mobility enhancers, methods and articles of manufacture) disclosed herein may be made in the absence of certain ingredients, and, i.e., be free of certain materials whether added or generated in situ other than minor amounts of contaminants, or may be free or substantially free from many ingredients used in compositions for similar purposes in the prior art. Specifically, it is increasingly preferred in the order given, independently for each preferably minimized ingredient listed below, that at least some embodiments according to the invention contain no more than 1.0, 0.5, 0.35, 0.10, 0.08, 0.04, 0.02, 0.01, 0.001, or 0.0002 percent, more preferably said numerical values in grams per liter, more preferably said numerical values in ppm, of each of the following constituents: silane and/or siloxane-based materials, epoxy resin, including bisphenol-based resins, PFAS; waxes, whether from plants, animals, or mineral origin, e.g. carnauba wax, beeswax, Montan wax, petrochemical-based waxes, synthetic waxes, or esters of long-chain fatty acids with long-chain monohydric alcohols; copper; oxidizing agents such as peroxyacids, permanganate, perchlorate, chlorate, chlorite, hypochlorite, perborate, hexavalent chromium, trivalent chromium, sulfuric acid and sulfate, nitric acid and nitrate ions; as well as fluorine, formaldehyde, formamide, hydroxylamines, cyanides, cyanates; rare earth metals; boron, e.g. borax, borate; strontium; free halogen ions, e.g., fluoride, chloride, bromide or iodide; and/or, or a combination thereof.

This section provides a general summary of the disclosure and is not a comprehensive disclosure of its full scope or all features, aspects or objectives. These and other features and advantages of this disclosure will become more apparent to those skilled in the art from the detailed description of a preferred embodiment. The drawings that accompany the detailed description are described below.

### BRIEF DESCRIPTION OF THE DRAWINGS

FIGS. 1A & 1B depict slip angle test results of an evaluation of the effect of PEG molecular weight in mobility enhancing compositions, applied to metal in varied concentrations, on slip angle of a metal surface that has been subjected to cleaning. FIG. 1A shows slip angles of mobility enhancing compositions without (w/o) surfactant and FIG. 1B shows slip angles of mobility enhancing compositions containing (w/) surfactant.

FIGS. 2A & 2B depict results of an evaluation of the effect of PEG molecular weight in mobility enhancing compositions, applied to metal in varied concentrations, on slip angle of a metal surface that has been subjected to a conversion coating (w/CC) process. FIG. 2A shows slip angles of mobility enhancing compositions without (w/o) surfactant and FIG. 2B shows slip angles of mobility enhancing compositions containing (w/) surfactant.

FIGS. 3A & 3B provide the results of an evaluation of the effect of different mobility enhancing compositions on slip angle as a function of concentration with respect to metal surfaces that have been conversion coated. FIG. 3A shows slip angles of Comparative Examples of mobility enhancing compositions and FIG. 3B shows slip angles of mobility enhancing compositions according to the invention.

FIG. 4 illustrates the results of an evaluation of foam volume (ml) with respect to different mobility enhancing compositions.

FIGS. 5A &5B provide slip angle test results of varying amounts of mobility enhancing compositions containing PEG 8000, with or without a surfactant component, on clean bare metal containers (see FIG. 5A) and on clean conversion coated metal containers (see FIG. 5B).

### DETAILED DESCRIPTION OF ILLUSTRATIVE EMBODIMENTS

The present invention may be understood more readily by reference to the following detailed description taken in connection with the accompanying examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

The invention relates to improvements in mobility enhancing composition and processes which accomplish at least one, and most desirably all, of the following related objectives when applied to formed metal surfaces, more particularly to the surfaces of cleaned, and optionally conversion coated, aluminum cans (i) reducing the coefficient of static friction of the treated surfaces after drying of such surfaces, without adversely affecting the adhesion of paints, including basecoats and inks, or lacquers applied thereto; (ii) promoting the drainage of water from treated surfaces; (iii) reduction of foaming characteristics in the process tanks; and (iv) reducing the tendency of the mobility enhancing composition to “bake-off” when exposed to longer oven times during line stoppages.

As described above, mobility enhancers are a desired aspect of metal pretreatment processes because they enable efficient travel of metal parts through manufacturing equipment and conveyor systems increasing processes' efficiency. Previous mobility enhancing compositions have not fulfilled all of the requisite characteristics for uses in high-speed can processing lines, including adherence to FDA regulatory requirements, low foaming, sufficient slip (reducing container surface coefficient of friction), and compatibility with conversion coatings and lacquers. The present inventors have discovered that polyethylene glycol in a certain molecular weight range and in combination with surfactant can be used in an aqueous mobility enhancing composition to produce a mobility enhancer with each of the aforementioned characteristics.

Polyethylene glycol (PEG) is a polymerized organic material that is produced by the reaction of ethylene oxide with water, polymerization of ethylene glycol and/or ethylene glycol oligomeric building blocks, and can have different geometries based on how it is synthesized. Branched PEGs may have three to ten PEG chains attached to a central core group, star PEGS may have 5 to 100 PEG, preferably 10 to 90 chains attached to a central core group. Typical core groups may be based on, by way of non-limiting example, glycerol, erythritol, sorbitol or TMP. Comb PEGs have multiple PEG chains grafted onto a polymer backbone. Most PEGs include a plurality of molecules with a distribution of molecular weights.

In the case of metal container manufacturing, such as aluminum can manufacturing, a mobility enhancing composition, also referred to herein as a slip agent, is applied to a surface of the container. This slip agent preferably provides a relative slip angle (measured as is known in the container industry using a tilt table whose angle is increased incrementally until there is movement of the containers according to the test procedure) to 30° or lower, with and without an underlying conversion coating or corrosion inhibitor that was initially applied directly to the container surface. For example, a measured slip angle of 30° (shown in the Figures as a dashed line) is considered sufficient for the high speeds of processing on a manufacturing line, although not preferred, higher slip angles less than 40° or 35° may be acceptable for some processing lines.

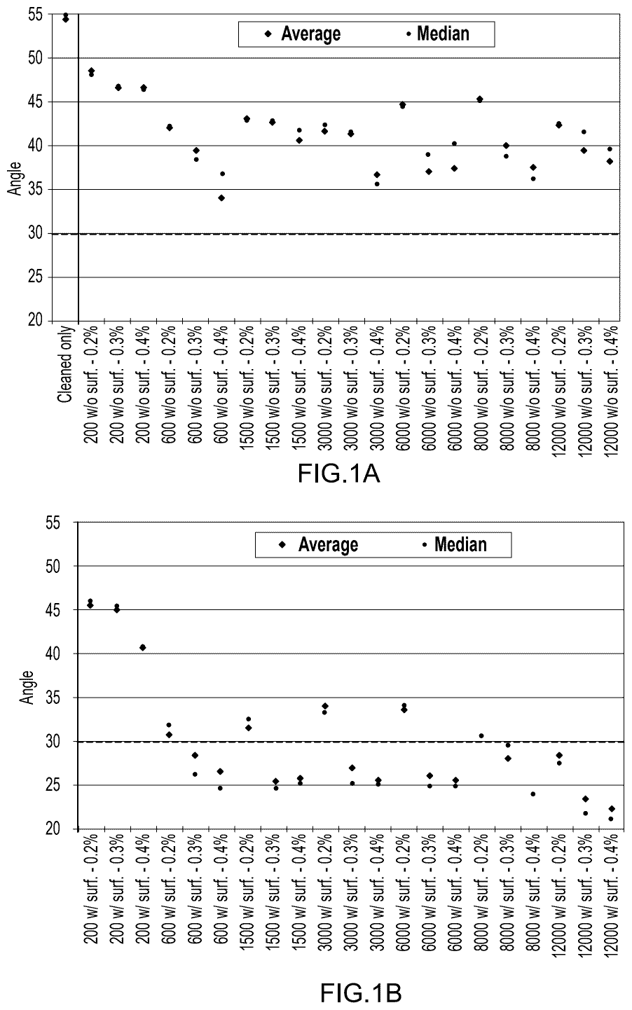

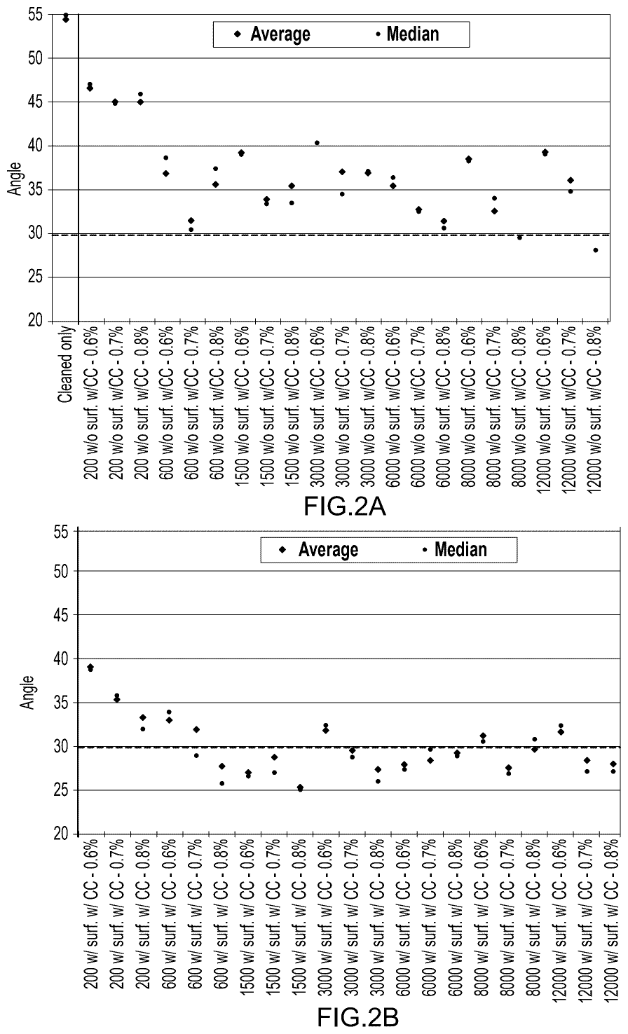

In a first screening experiment, it was found that PEG alone reduced the coefficient of friction, but not to the desired 30° requirement: as shown in FIG. 1A, regardless of the molecular weight of the tested PEG molecule, the slip angle of a container surface to which only PEG has been applied remained above 30°. Nonetheless, some of the PEG only concentrations showed slip angles of about 35°, rendering them potentially suitable for less demanding speeds and applications in container processing plants. Adding PEG to a surface of a metal container to which a conversion coating was first applied does not yield a 30° slip angle, see FIG. 2A.

However, the present inventors have discovered that combining PEG with a surfactant component produces compositions that achieve a lower slip angle in ranges of less than 40°, desirably less than 35°, preferably less than about 30°, when applied to a bare metal surface, see FIG. 1B, and in some embodiments similar performance is seen on conversion coated metal surfaces, see FIG. 2B. Accordingly, disclosed herein are aqueous mobility enhancing composition for improving travel of metal containers through a manufacturing process, the composition comprising polyethylene glycol (PEG), a surfactant component, and optionally a biocidal agent.

The polyethylene glycol (PEG) may have a molecular weight of about 200 to about 15,000 Dalton. For example, the PEG may have a molecular weight of about 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 5000, 5200, 5400, 5600, 5800, 6000, 6200, 6400, 6600, 6800, 7000, 7200, 7400, 7600, 7800, 8000, 8200, 8400, 8600, 8800, 9000, 9200, 9400, 9600, 9800, 10,000, 10,500, 11,000, 11,500, 12,000, 12,500, 13,000, 13,500, 14,000, 14,500, or 15,000 Dalton. In some embodiments, the PEG has a molecular weight of about 1,000 to 12,000, 2,000 to 12,000, 3,000 to 11,000, 4,000 to 11,000, 5,000 to 10,000, 6,000 to 10,000, 7,000 to 10,000, or 7,000 to 9,000 Dalton.

The PEG may be present in the aqueous mobility enhancing composition (e.g. working spray bath) in an amount of about 1,500 ppm up to the solubility limit of the PEG in the composition. In certain embodiments, the PEG is present in the aqueous mobility enhancing composition in an amount of about 1,500 to 12,000, 1,500 to 11,000, 1,500 to 10,000, 1,500 to 9,000, 1,500 to 8,000, 1,500 to 7,000, 1,500 to 6,000, or 1,500 to 5,000 ppm.

The surfactant component may be any surfactant compound or a combination of surfactant compounds, provided that the surfactant component is soluble in water or, if not soluble, then dispersible in water and soluble or dispersible in the aqueous mobility enhancing composition, as applied. The surfactant component is also compatible with the PEG component, which in combination therewith achieves an aqueous mobility enhancing composition that reduces coefficient of friction when applied and dried on a metal container, preferably providing a slip angle of less than 39, 38, 37, 36, 35, 34, 33, 32, 31 or 30°°.

Important features of the surfactant component may include one or more of: generating foam test results of the claimed aqueous mobility enhancing composition having volume and persistence equivalent to or less than foam test results of benchmark aqueous mobility enhancing compositions; no emulsion formation visible to the naked eye in the aqueous mobility enhancing composition; making up less than 1 wt. %, desirably less than 1 g/l or preferably less than 1 ppm of solid precipitation in the concentrate and/or the working composition that cannot be redissolved by mixing; resulting in less than 1 wt. %, desirably less than 1 g/l or preferably less than 1 ppm liquid phase separation in the aqueous mobility enhancing composition that cannot be dispersed by mixing.

In a preferred embodiment, the surfactant or surfactant combination is soluble in water and the aqueous mobility enhancing composition in the concentrations used in making and using the invention. Desirably the surfactant component comprises a non-ionic surfactant, preferably a plurality of non-ionic surfactants, different from each other. The surfactant component may comprise a non-ionic surfactant, with or without a coupling agent enhancing solubility of the non-ionic surfactant.

In certain embodiments, the surfactant component may comprise a plurality of surfactants different from each other, in structure, size and/or functional group(s). In one embodiment, the surfactant component comprises an ethylene glycol-polyalkylene oxide copolymer. In other instances, the surfactant component comprises a first ethylene glycol-polyalkylene oxide copolymer and a second ethylene glycol-polyalkylene oxide copolymer that is different from the first ethylene glycol polyalkylene oxide copolymer (hereinafter referred to as “different from each other”). In the copolymer surfactants comprising ethylene glycol and polyalkylene oxide, the polyalkylene oxide subunit may be, for example, a polymethylene-, polyethylene-, polypropylene-, or polybutylene oxide molecule, or any combination thereof.

When the surfactant component comprises a first ethylene glycol-polyalkylene oxide copolymer and a second ethylene glycol-polyalkylene oxide copolymer, which are different from each other, the first ethylene glycol-polyalkylene oxide copolymer may comprise a copolymer of propylene oxide and ethylene oxide, preferably a random copolymer, a block copolymer, an ethylene oxide end-capped copolymer, or a combination thereof. In some preferred embodiments, the first ethylene glycol-polyalkylene oxide copolymer comprises a hydrophilic, with HLB>9, triblock copolymer of polyethylene oxide-polypropylene oxide-polyethylene oxide, comprised of at least 50, 55, 60, 65, 70, 75, 80, 85 or 90% ethylene oxide moieties, and not more than 45, 40, 35, 30, 25, 20, 15 or 10% propylene oxide moieties, and may desirably have an HLB>20. The first ethylene glycol-polyalkylene oxide copolymer may have an average molecular weight of at least about 5,000, 5,500, 6,000, 6,500, 7,000, 7500 or 7,800 Dalton up to about in increasing order of preference 10,000, 9,800, 9,600, 9,500, 9,400, 9,300, 9,200, 9,100, 9,000, 8,800, 8,600, 8,500, 8,400, 8,300, 8,200, 8,100, 8,000 or 7,900 Dalton.

In some embodiments where the surfactant component comprises a first ethylene glycol-polyalkylene oxide copolymer and a second ethylene glycol-polyalkylene oxide copolymer, which are different from each other, the first ethylene glycol-polyalkylene oxide copolymer may be present in an amount of about 15 ppm up to the solubility limit of the first ethylene glycol-polyalkylene oxide copolymer in the composition. For example, the first ethylene glycol-polyalkylene oxide copolymer may be present in an amount of, in increasing order of preference, at least about 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 ppm, and not more than, at least for economic reasons, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 ppm in the composition. In some embodiments, the first ethylene glycol-polyalkylene oxide copolymer may be present in an amount of about 15 to 100 ppm, about 15 to 95 ppm, about 15 to 90 ppm, about 15 to 85 ppm, or about 16 to 80 ppm. In certain embodiments where the surfactant component comprises a first ethylene glycol-polyalkylene oxide copolymer and a second ethylene glycol-polyalkylene oxide copolymer, which are different from each other, the second ethylene glycol-polyalkylene oxide copolymer may comprise a copolymer of propylene oxide and ethylene oxide, preferably a random copolymer, a block copolymer, an ethylene oxide end-capped copolymer or a combination thereof. In such embodiments, the second ethylene glycol-polyalkylene oxide copolymer may have a molecular weight of about 1,000 to 5,000 Dalton, such as about 1,000 to 4,500, 1,200 to 4,000, or 1,500 to 3,500 Dalton. In certain embodiments, the second ethylene glycol-polyalkylene oxide copolymer may comprise a difunctional block copolymer surfactant, e.g. ethylene oxide propylene oxide copolymer, comprising about 5 to 40 wt. %, preferably 10 to 30 wt. % ethylene oxide and terminating in primary hydroxyl groups. In some embodiments, the second ethylene glycol-polyalkylene oxide copolymer comprises a hydrophobic, with HLB<8, preferably less than 5, triblock copolymer of polyethylene oxide-polypropylene oxide-polyethylene oxide.

In some embodiments where the surfactant component comprises a first ethylene glycol-polyalkylene oxide copolymer and a second ethylene glycol-polyalkylene oxide copolymer, which are different from each other, the second ethylene glycol-polyalkylene oxide copolymer may be present in an amount of about 1 ppm up to the solubility limit of the second ethylene glycol-polyalkylene oxide copolymer in the composition. For example, the second ethylene glycol-polyalkylene oxide copolymer may be present in an amount of, in increasing order of preference, about 1, 2, 3, 4, 5, 6, 7, 8, 9 or 10 ppm and not more than, at least for economic reasons, about 11, 12, 13, 14, 15, 16, 17, 18, 19, 20, 21, 22, 23, 24, 25, 26, 27, 28, 29, or 30 ppm in the composition. In some embodiments, the second ethylene glycol-polyalkylene oxide copolymer may be present in an amount of about 1 to 30 ppm, about 1 to 20 ppm, about 1 to 10 ppm, about 2 to 10 ppm, about 2 to 8 ppm, or about 2 to 6 ppm.

In some embodiments where it may be desirable to include lesser amounts of PEG in the working spray bath, e.g. in a range of about 1500 ppm to 5000 ppm, the amount of surfactant component may be increased and where the surfactant component comprises a first ethylene glycol-polyalkylene oxide copolymer and a second ethylene glycol-polyalkylene oxide copolymer, which are different from each other, the first ethylene glycol-polyalkylene oxide copolymer may be present in an amount of about 15 ppm up to the solubility limit of the first ethylene glycol-polyalkylene oxide copolymer in the composition and the second ethylene glycol-polyalkylene oxide copolymer may be present in an amount of about 1 ppm up to the solubility limit of the second ethylene glycol-polyalkylene oxide copolymer in the composition. The greater amount of surfactant component is particularly beneficial for containers where no subsequent conversion coating is applied and unmarked and shiny exterior surfaces are desirable.

In some embodiments wherein the surfactant component comprises a first ethylene glycol-polyalkylene oxide copolymer and a second ethylene glycol-polyalkylene oxide copolymer that is different from the first ethylene glycol polyalkylene oxide copolymer, the ratio of the first ethylene glycol-polyalkylene oxide copolymer to the second ethylene glycol-polyalkylene oxide copolymer may be in a range of about 2:1 to about 0.75:1, desirably in a range of about 1.5:1 to 0.95:1 preferably in a range of about 1.3:1 to 1:1.

The present aqueous mobility enhancing compositions preferably further comprise a biocidal agent. The biocidal agent may be, for example, 2-Methyl-4-isothiazolin-3-one, another biocide acceptable for use in the can manufacturing art, or any combination thereof.

Also disclosed herein are concentrates that are useful in forming an aqueous mobility enhancing composition by dilution with water, the concentrate comprising polyethylene glycol (PEG), a surfactant component, and preferably a biocidal agent. In the present concentrates, the respective identities and characteristics of the PEG, surfactant component, and biocidal agent may be the same, +/−10%, as those described above in connection with the presently disclosed aqueous mobility enhancing compositions, present in greater amounts and typically in ratios similar to or the same as those of the working aqueous mobility enhancing composition. For example, a desirable ratio of total surfactant component to total PEG may be in a range of 5 pbw:100 pbw up to 15 pbw:100 pbw, preferably the ratio of total surfactant component may be about 7.5 or 8 or 8.5 pbw:100 pbw PEG to not more than, at least for economy's sake, about 10, 9.5, 9 pbw surfactant component: 100 pbw PEG. The concentration of the PEG in the present concentrates may be in a range of about 150-50 g/l, preferably 125-75 g/l most preferably 100 g/1. In embodiments in which the surfactant component comprises a first ethylene glycol-polyalkylene oxide copolymer and a second ethylene glycol-polyalkylene oxide copolymer that is different from the first ethylene glycol polyalkylene oxide copolymer, the first ethylene glycol-polyalkylene oxide copolymer may be present in the concentrate in an amount ranging from about 6-2 g/l, preferably 5-3 g/l most preferably about 4 g/l, and the second ethylene glycol-polyalkylene oxide copolymer may be present in the concentrate in an amount in a range of about 7-2 g/l, preferably 5.5-3.5 g/l most preferably 4.5 g/l. The biocidal agent may be present in the concentrate in an amount of about 1.0 g/l to 0.01 g/l, preferably in an amount sufficient to provide the concentrate with stability against microbial growth, as shown by constant slip angle, + or −10%, after storage at 60° C. for 7 days. The concentrate is preferably such that the PEG and surfactant are dissolved in order to provide a single phased solution.

The present disclosure also provides methods for making an aqueous mobility enhancing composition for reducing a coefficient of friction of a surface of a metal container comprising mixing a concentrate as provided herein with an aqueous diluent. The aqueous diluent may be, for example, water (such as distilled water, deionized water, reverse osmosis water, or the like), city water or tap water may be used provided materials dissolved therein do not impair the functioning of the invention. The mixing of the concentrate with the aqueous diluent may be performed under ambient temperatures, such as at a temperature of about 15-32° C. The amount of concentrate that is mixed with the aqueous diluent may vary depending on the end use: for example, the mixing may result in about 1 g/L-5 g/L, about 1 g/L to 4 g/L, about 2 g/L-4 g/L of concentrate for use with non-conversion coated metal surfaces, or may result in about 5 g/L-8 g/L, about 6 g/L-8 g/L, about 6 g/L-7 g/L for use with conversion coated metal surfaces.

The present disclosure also provides methods for reducing a coefficient of friction of a surface of a container, preferably a metal surface, most preferably a conversion coated metal surface, the method comprising contacting the surface of the container with an aqueous mobility enhancing composition according to the present disclosure, followed by drying the composition in place. The container may be a can, bottle, box, cannister, or any other container that benefits from a reduced slip angle, such as for the purpose of improving travel through a manufacturing process. An exemplary metal container includes an aluminum beverage can. In certain embodiments, the present methods result in a slip angle after drying of 35° or lower, such as to between 2° and 35°, 2° and 30°, 5° and 30°, 8° and 30°, 10° and 30°, or 15° and 30°, or to about 1, 2, 3, 4, 5, 6, 7, 8, 9, 10, 11, 12, 13, 14, 15 16, 17, 18, 19, 20, 21, 22, 23, 24, 25, 26, 27, 28, 29, 30, 31, 32, 33 or 34°.

The mobility enhancing composition may be applied to the cans during the pretreatment process, more specifically at the end of the cleaning cycle and most specifically after the conversion coating treatment and after the last rinse such that when entering the oven after pretreatment, the mobility enhancing compositions is the last application to the can. The step of contacting the surface of the metal container with the composition may include immersing the surface in the composition, or applying the composition to the surface, such as by brushing, roll-coating or spraying. In preferred embodiments, the composition is sprayed onto a metal surface of a metal container. This mobility enhancing composition desirably is sprayed onto the surface of the can by a fine mist that reacts with the aluminum surface through chemisorption or physisorption to provide the desired film adhered thereto.

Following the contacting step, the composition is dried in place on the surface of the metal container. Drying may be accomplished by exposure to ambient conditions, or by heating, such as using convection and/or radiant heat, at a temperature in a range of about 100-200° C., preferably at least 150, 160, 170, 180, 190 or 195° C. and no more then 204, 203, 202, 201, 200° C.

Also provided are metal containers comprising a surface having a coefficient of friction that has been reduced using any of the presently disclosed methods for reducing a coefficient of friction. Further disclosed are metal containers comprising a surface that has been contacted with an aqueous mobility enhancing composition according to any of the presently disclosed embodiments. As noted, the metal container may be, for example, a can, bottle, box, cannister, and the surface may be an outer side, top, or underside, or an interior side, top, or underside of the metal container. In certain embodiments, the surface of the metal container has a slip angle 35° or lower, such as to between 2° and 35°, 2° and 30°, 5° and 30°, 5° and 25°, 10° and 25°, or 15° and 25°, or about 1, 2, 3, 4, 5, 6, 7, 8, 9, 10, 11, 12, 13, 14, 15 16, 17, 18, 19, 20, 21, 22, 23, 24, 25, 26, 27, 28, 29, or 30°.

The present disclosure also provides methods for processing a metal container comprising forming the metal into an intermediate shape, which may be by slitting metal sheets and bonding opposing edges into a tube to be capped at both ends or cutting discs from the metal sheets and forming them using dies, creating an unfinished metal container open at one end; guiding the metal container, typically an aluminum, steel or tin-plated steel can, preferably an aluminum can, through a manufacturing process, wherein the metal container may be cleaned, deoxidized, and/or conversion coated, generally with rinsing between steps. After these steps, the container is contacted with an aqueous mobility enhancing composition according to any embodiment disclosed herein, and the aqueous mobility enhancing composition is dried in place, with no rinsing between application and drying thereby forming a mobility enhancer deposited on can surfaces. Also provided are methods for processing a metal container comprising guiding the metal container through a manufacturing process, wherein the metal container comprises a surface having a coefficient of friction that has been reduced using a presently disclosed method. The manufacturing process may be a process line for manufacturing, shaping, and/or decorating a metal container, such as an aluminum beverage can manufacturing process that includes decorating with product and brand information, shaping the bottom of the container and forming the open edges of the container to accept a cap on one or both ends, as well as lacquering the outside and/or applying the interior coating (IC). Guiding the metal container may include any standard manufacturing process procedures, the critical feature being reducing friction from moving containers contacting each other, processing equipment, e.g. track work, decorators, neckers and the like, and/or the conveyor system moving the containers through the process steps. In some embodiments, compositions of the invention may be used to reduce the coefficient of friction of metal containers, intended for uses other than holding food or beverages, but which travel through manufacturing processes including conveyor systems and manufacturing equipment and which would benefit from better slip angles provided by the invention, non-limiting examples may include necked-in or straight wall aerosol cans, cannisters, gift containers and the like.

The present disclosure also provides containers having coatings on metal surfaces thereof comprising a mobility enhancer that is formed by contacting the surface with an aqueous mobility enhancing composition according to any presently disclosed embodiment and drying the composition in place on the container. Coating weight of the mobility enhancer layer after initial application and drying may be in a range of about 3 mg/m² to about 60 mg/m², about 20 mg/m² to about 55 mg/m²m, desirably about 30 mg/m² to about 50 mg/m², which measurements are made by methods known in the art and may vary +/−10%. In some embodiments, the coating has a coating weight of 39-48 mg/m². In some embodiments, the dried coating may be in a monolayer form (i.e. a complete layer of mobility enhancer coating the metal surface), optionally the layer may have a thickness approximately equal to one molecule thick.

In some embodiments, the coating further comprises a conversion coating layer that is interposed between the metal surface and the mobility enhancer. The conversion coating layer is deposited on metal can surfaces by known means including contacting them with a reactive conversion coating composition for a time sufficient to form the conversion layer by reaction of the metal surfaces of the container with the conversion coating composition. Examples of conversion coatings useful in the invention include zirconium oxide, titanium oxide, zirconium phosphate, titanium phosphate and combinations thereof and others known in the container processing field. The conversion coated metal can is then rinsed and contacted with an aqueous mobility enhancing composition, which is dried in place to form the mobility enhancer layer on the can surfaces.

The present invention is further defined in the following Examples. It will be understood that these examples, while indicating preferred embodiments of the invention, are given by way of illustration only, and should not be construed as limiting the appended claims. From the above discussion and these examples, one skilled in the art can ascertain the essential characteristics of this invention, and without departing from the spirit and scope thereof, can make various changes and modifications of the invention to adapt it to various usages and conditions.

### EXAMPLES

In seeking to improve performance of mobility enhancers, various aqueous mobility enhancing compositions were made and performance tested. Test compositions were made as follows, unless indicated otherwise: PEG and any surfactant component used were combined with water and mixed until uniform, optional biocide was then added, additional water was added, as necessary to obtain desired concentration of working mobility enhancing composition. Test aqueous mobility enhancing composition samples were visually examined for any formation of an emulsion or a precipitate.

Application of aqueous mobility enhancing compositions: Test samples were sprayed onto commercially available clean aluminum cans, some having no coating on the metal surfaces and some having a conversion coating (CC) deposited on the metal surfaces. The mobility enhancing compositions were sprayed onto the metal cans at ambient temperature for 30 seconds, dried in place in an oven at 150° C. for 5 minutes, and the cans were permitted to cool to ambient temperature before testing.

### Slip Angle Testing

A chief performance measure for mobility enhancing compositions is reduction in slip angle, as further described herein. Slip angle correlates to static friction associated with the outside sidewall surface characteristics of aluminum cans; it is desirable to reduce friction and slip angle to reduce jamming as cans move thorough processing lines.

The mobility/slip angle testing was performed using mobility of metal containers WI MH-R&D 843 3.1-03, which is a procedure that provides a measure of the relative coefficient of static friction of drawn and wall ironed metal containers. This procedure applies to the use of a “Can Mobility Tester,” a custom-built apparatus, but similar test equipment is available commercially, from AGR International, Inc. or Industrial Physics LLC.

Unless indicated otherwise, slip angle was tested according to the following procedure: Loaded the test cell—two cans were placed on the chocks of the selected test cells, with their longitudinal axis parallel to the tilt table, with open end facing away from the user. At each selected test cell, a third can was placed in the valley formed by the two base cans, open end facing the user, longitudinal axis parallel to those of the base cans. A cell ready indicator was used, which illuminated when all 3 cans are properly seated and the test group was in the path of an optical sensor. Test personnel visually confirmed that the cans were not askew and were contacting each other uniformly. Measurement of slip angle was made by activating a tilt table cycle which initiated ramp rise, increasing angle of incline of the tilt table. The ramp reversed direction when all of the cans in the test cell had slid out of the path of the optical sensor and the associated slip angle was displayed on the device and recorded. Data Reduction: The recorded slip angles were used to calculate confidence intervals seen on the Figures.

If desired, the slip angle may be converted to coefficient of friction (COF) with the following equation:

$$COF = \frac{Tangent ( X° Slip Angle ) ( π )}{180 °}$$

Slip angle is evaluated as acceptable based on product requirements. The lesser the slip angle (meaning closer to horizontal) the better, as it indicates less friction is present resisting sliding of the cans' surfaces relative to each other. Generally any angle less than 35° is considered acceptable for high speed container processing lines (about 1000 to 2000 cans/min. and potentially more).

### Example 1: Mobility Enhancing Compositions Comprising Various Concentrations and Molecular Weights of Polyethylene Glycol (PEG) without a Surfactant Component

Test compositions were made as follows, unless indicated otherwise: For each PEG molecular weight tested, a master concentrate batch comprising the selected MW of PEG & water was made by mechanically mixing the components until uniformly combined, see Table 1.

TABLE 1
Concentrate Composition of PEG only

| | PEG 200 | PEG 600 | PEG 1500 | PEG 3000 | PEG 6000 | PEG 8000 | PEG 12,000 |
|---|---|---|---|---|---|---|---|
| Component | ME | ME | ME | ME | ME | ME | ME |
| DI Water | 899.90 | 899.90 | 899.90 | 799.90 | 899.90 | 899.90 | 899.90 |
| PEG 200 | 100.00 | | | | | | |
| PEG 600 | | 100.00 | | | | | |
| PEG 1500 | | | 100.00 | | | | |
| PEG 3000 | | | | 200.00 | | | |
| (50% active) | | | | | | | |
| PEG 6000 | | | | | 100.00 | | |
| PEG 8000 | | | | | | 100.00 | |
| PEG 12000 | | | | | | | 100.00 |
| Biocide | 0.10 | 0.10 | 0.10 | 0.10 | 0.10 | 0.10 | 0.10 |
| | 1000.00 | 1000.00 | 1000.00 | 1000.00 | 1000.00 | 1000.00 | 1000.00 |

ME: Mobility Enhancer

Test samples for selected PEG MW were made by diluting the 100 g/l PEG ME concentrate with water to produce test samples of mobility enhancing compositions without surfactant component (w/o surf.) which were applied, dried and slip angle tested as described above. Results for PEG as a mobility enhancer alone on bare metal are shown in FIG. 1A, with x-axis designations indicating: “molecular weight of PEG-presence or absence of surfactant-concentration” of mobility enhancing composition tested. For example, “200 w/o surf.-0.2%”, indicates a mobility enhancing composition in a working concentration of 0.2 wt. % containing PEG MW 200, without surfactant.

FIG. 2A shows slip angle results for PEG as a mobility enhancer alone on conversion coated metal, with similar x-axis designations indicating: “molecular weight of PEG-presence/absence of surfactant-concentration” of mobility enhancing composition tested, e.g. “200 w/o surf. w/CC-0.6%”, identified a mobility enhancing composition applied at a working concentration of 0.6 wt. % containing PEG MW 200, without surfactant onto a conversion coated metal substrate.

PEG alone was insufficient to confer a measured slip angle of 30°° or less when applied directly onto a clean bare metal surface (FIG. 1A), or when applied onto a conversion-coated metal surface (FIG. 2A). For some less challenging applications, that only require bare metal slip angles in a range of 34 to 40°, PEG of MW 600 to 12,000 in concentrations of 2 g/l to 4 g/l may be satisfactory.

### Example 2—Surfactant Component Screening

In a further investigation, a number of different surfactants were tested as additives to different PEG-based mobility enhancing compositions having PEG MW of 1500 and 8000 in an attempt to lower the slip angle for high-speed applications, and with respect to metal surfaces bearing a conversion coating underlayer. Because a main challenge pertains to the conversion coated cans, a focus was placed on the conversion coated-metal container surfaces specifically due to the tendency of conversion coatings to confer surface roughening (which undesirably increases slip angle and coefficient of friction).

Containers traveling on a high-speed, high-volume canning line experience a variety of influences as they are conveyed. Speed transitions, bends, mass accumulation, inclines and declines all affect throughput and require high performance mobility enhancers that reduce coefficient of friction to prevent jams and line stoppages. Most high speed can processing plants, moving 1000 or more cans per minute require slip angle performance at or below 30°

### PEG MW 1500

In a first screening experiment, nonionic hydrophobic surfactant (Surfactant A) was added to a test PEG-only mobility enhancing composition comprising PEG MW 1500, present in an amount of 0.6 g/l. Surfactant A was present in amounts of 0.06 g/l or 0.12 g/l at 100% actives. This first surfactant was an EO/PO block co-polymer, based on ethylene glycol starter and having about 20 wt. % EO, and two primary hydroxyl functional groups. The first surfactant had a molecular weight in a range of about 2000 to 3000 and dissolved readily to form a mobility enhancing composition. The composition was applied, dried and the slip angle provided by this test material was tested as described above. The dried in place mobility enhancer based on this composition did not provide the desired 30° slip angle in combination with PEG of MW 1500. The measured slip angles for the used concentrations were 41 and 42°, respectively.

In a second screening experiment, another nonionic surfactant, (Surfactant B), a fatty acid polyglycol ester based on an isostearic acid was added to the nonionic hydrophobic surfactant (Surfactant A) at a ratio of 1:1, both in concentrations of 0.03 g/l. PEG MW 1500 concentration was the same as in the first screening experiment. Slip angle testing showed a slight reduction in slip angle to 40°°.

In a third screening experiment, another nonionic surfactant (Surfactant C) was added to PEG MW 1500 to form a mobility enhancing composition. PEG MW 1500 concentration was the same as in the first screening experiment. Surfactant C, a symmetric triblock copolymer comprising both polyethylene oxide (PEO) and polypropylene oxide (PPO) in an alternating linear fashion (PEO-PPO-PEO), having greater amounts of ethylene oxide and a greater average molecular weight (about 5,800 Daltons) than Surfactant A, was tested in the PEG MW 1500 with Surfactant A, both surfactants present in concentrations of 0.03 g/l. Surfactant C produced minor improvements when used in combination with 0.03 g/l Surfactant A, of about 10% better slip angle (slip angle of) 36° than the combination of Surfactants A & B.

### PEG MW 8000

In fourth screening experiment, a concentration of 0.6 g/l of PEG MW 8000 was utilized with the combination of Surfactants A & C, at concentration of 0.03 g/l for each surfactant present, resulting in improvement in slip angle (slip angle of) 30°. Two other nonionic surfactants similar to Surfactant C, differing in molecular weight were also tested in combination with Surfactant A.

Surfactant D, a difunctional block copolymer surfactant terminating in primary hydroxyl groups having a MW of about 4700 Dalton), was tested in a mobility enhancing composition as follows: a concentration of 0.6 g/l of PEG MW 8000 was utilized with the combination of Surfactants A & D, at concentration of 0.03 g/l for each surfactant present. This mobility enhancing composition produced a mobility enhancer that displayed similar slip angle performance to Surfactant C in combination with Surfactant A.

Surfactant E, a triblock copolymer of polyethylene oxide-polypropylene oxide-polyethylene oxide (PEO-PPO-PEO) and molecular weight of 8400 Daltons was also tested. The combination of Surfactants A & E (each at a concentration of 0.03 g/l) with PEG MW 8000, at a concentration of 0.06 g/l, brought the slip angle down to 30°, which represented a significant improvement for high-speed processing.

### Example 3: Mobility Enhancing Compositions Comprising Polyethylene Glycol (PEG) and a Surfactant Component

For each PEG molecular weight tested, a master concentrate batch comprising the selected MW of PEG, surfactant component & water was made by mechanically mixing the components listed in Table 2 until uniformly combined.

TABLE 2
Concentrate Compositions of PEG with Surfactant Component

| | PEG 200 | PEG 600 | PEG 1500 | PEG 3000 | PEG 6000 | PEG 8000 | PEG 12,000 |
|---|---|---|---|---|---|---|---|
| | ME | ME | ME | ME | ME | ME | ME |
| DI Water | 891.40 | 891.40 | 891.40 | 791.40 | 891.40 | 891.40 | 891.40 |
| PEG 200 | 100.00 | | | | | | |
| PEG 600 | | 100.00 | | | | | |
| PEG 1500 | | | 100.00 | | | | |
| PEG 3000 | | | | 200.00 | | | |
| (50% active) | | | | | | | |
| PEG 6000 | | | | | 100.00 | | |
| PEG 8000 | | | | | | 100.00 | |
| PEG 12000 | | | | | | | 100.00 |
| Surfactant A | 4.00 | 4.00 | 4.00 | 4.00 | 4.00 | 4.00 | 4.00 |
| Surfactant E | 4.50 | 4.50 | 4.50 | 4.50 | 4.50 | 4.50 | 4.50 |
| Biocide | 0.10 | 0.10 | 0.10 | 0.10 | 0.10 | 0.10 | 0.10 |
| | 1000.00 | 1000.00 | 1000.00 | 1000.00 | 1000.00 | 1000.00 | 1000.00 |

Surfactant containing test samples for each selected PEG MW mobility enhancing compositions were made by diluting the concentrates shown in Table 2 with different amounts of water to obtain different concentrations of working mobility enhancing compositions. These PEG with surfactant component (w/surf.) mobility enhancing compositions were applied, dried and slip angle tested as described above. Table 3 shows median and average slip angles of the formulations.

TABLE 3
Slip Angle Test Results of Uncoated or Conversion Coat Aluminum Cans,
Treated with Various Mobility Enhancing Compositions*

| Uncoated Cans | | | Conversion Coated Cans | | |
|---|---|---|---|---|---|
| with | | | with | | |
| Mobility Enhancing | | | Mobility Enhancing | | |
| Formulations | Median | Average | Formulations | Median | Average |
| (PEG MW, surfactant | Slip | Slip | (PEG MW, surfactant use, | Slip | Slip |
| use, [ME]) | Angle | Angle | [ME]) | Angle | Angle |
| Cleaned only | 54.8 | 54.0 | Cleaned only | 54.8 | 54.0 |
| 200 w/o surf. - 0.2% | 48.2 | 48.6 | 200 w/o surf. w/CC - 0.6% | 47.1 | 46.5 |
| 200 w/o surf. - 0.3% | 46.7 | 46.5 | 200 w/o surf. w/CC - 0.7% | 45.1 | 45.3 |
| 200 w/o surf. - 0.4% | 46.5 | 46.7 | 200 w/o surf. w/CC - 0.8% | 46.0 | 44.9 |
| 600 w/o surf. - 0.2% | 42.2 | 41.9 | 600 w/o surf. w/CC - 0.6% | 38.8 | 36.9 |
| 600 w/o surf. - 0.3% | 38.5 | 39.5 | 600 w/o surf. w/CC - 0.7% | 30.5 | 31.6 |
| 600 w/o surf. - 0.4% | 36.9 | 34.0 | 600 w/o surf. w/CC - 0.8% | 37.4 | 35.8 |
| 1500 w/o surf. - 0.2% | 42.9 | 43.1 | 1500 w/o surf. w/CC - 0.6% | 38.9 | 39.4 |
| 1500 w/o surf. - 0.3% | 42.6 | 42.5 | 1500 w/o surf. w/CC - 0.7% | 33.3 | 34.0 |
| 1500 w/o surf. - 0.4% | 41.6 | 40.5 | 1500 w/o surf. w/CC - 0.8% | 33.6 | 35.6 |
| 3000 w/o surf. - 0.2% | 42.2 | 41.5 | 3000 w/o surf. w/CC - 0.6% | 40.4 | 40.4 |
| 3000 w/o surf. - 0.3% | 41.4 | 41.2 | 3000 w/o surf. w/CC - 0.7% | 34.6 | 37.0 |
| 3000 w/o surf. - 0.4% | 35.7 | 36.7 | 3000 w/o surf. w/CC - 0.8% | 37.1 | 36.6 |
| 6000 w/o surf. - 0.2% | 44.5 | 44.6 | 6000 w/o surf. w/CC - 0.6% | 36.5 | 35.5 |
| 6000 w/o surf. - 0.3% | 39.0 | 37.1 | 6000 w/o surf. w/CC - 0.7% | 32.6 | 32.8 |
| 6000 w/o surf. - 0.4% | 40.3 | 37.4 | 6000 w/o surf. w/CC - 0.8% | 30.8 | 31.6 |
| 8000 w/o surf. - 0.2% | 45.2 | 45.4 | 8000 w/o surf. w/CC - 0.6% | 38.1 | 38.8 |
| 8000 w/o surf. - 0.3% | 38.9 | 40.0 | 8000 w/o surf. w/CC - 0.7% | 34.1 | 32.7 |
| 8000 w/o surf. - 0.4% | 36.3 | 37.6 | 8000 w/o surf. w/CC - 0.8% | 29.5 | 29.9 |
| 12000 w/o surf. - 0.2% | 42.4 | 42.2 | 12000 w/o surf. w/CC - 0.6% | 39.0 | 39.5 |
| 12000 w/o surf. - 0.3% | 41.6 | 39.6 | 12000 w/o surf. w/CC - 0.7% | 34.9 | 36.2 |
| 12000 w/o surf. - 0.4% | 39.7 | 38.3 | 12000 w/o surf. w/CC - 0.8% | 28.2 | 28.2 |
| 200 w/surf. - 0.2% | 46.0 | 45.5 | 200 w/surf. w/CC- 0.6% | 39.1 | 39.1 |
| 200 w/surf. - 0.3% | 45.5 | 45.0 | 200 w/surf. w/CC- 0.7% | 36.0 | 35.4 |
| 200 w/surf. - 0.4% | 40.8 | 40.6 | 200 w/surf. w/CC- 0.8% | 32.1 | 33.4 |
| 600 w/surf. - 0.2% | 31.9 | 30.7 | 600 w/surf. w/CC- 0.6% | 34.0 | 33.0 |
| 600 w/surf. - 0.3% | 26.2 | 28.4 | 600 w/surf. w/CC- 0.7% | 29.0 | 32.0 |
| 600 w/surf. - 0.4% | 24.6 | 26.5 | 600 w/surf. w/CC- 0.8% | 25.8 | 27.8 |
| 1500 w/surf. - 0.2% | 32.5 | 31.5 | 1500 w/surf. w/CC- 0.6% | 26.7 | 27.2 |
| 1500 w/surf. - 0.3% | 24.6 | 25.5 | 1500 w/surf. w/CC- 0.7% | 27.1 | 28.9 |
| 1500 w/surf. - 0.4% | 25.2 | 25.8 | 1500 w/surf. w/CC- 0.8% | 25.1 | 25.5 |
| 3000 w/surf. - 0.2% | 33.3 | 34.1 | 3000 w/surf. w/CC- 0.6% | 32.5 | 31.8 |
| 3000 w/surf. - 0.3% | 25.2 | 27.0 | 3000 w/surf. w/CC- 0.7% | 28.8 | 29.7 |
| 3000 w/surf. - 0.4% | 25.1 | 25.6 | 3000 w/surf. w/CC- 0.8% | 26.1 | 27.4 |
| 6000 w/surf. - 0.2% | 34.1 | 33.6 | 6000 w/surf. w/CC- 0.6% | 27.3 | 28.0 |
| 6000 w/surf. - 0.3% | 25.0 | 26.0 | 6000 w/surf. w/CC- 0.7% | 29.8 | 28.5 |
| 6000 w/surf. - 0.4% | 24.9 | 25.6 | 6000 w/surf. w/CC- 0.8% | 28.9 | 29.2 |
| 8000 w/surf. - 0.2% | 30.6 | 30.4 | 8000 w/surf. w/CC- 0.6% | 30.6 | 31.3 |
| 8000 w/surf. - 0.3% | 29.5 | 28.0 | 8000 w/surf. w/CC- 0.7% | 26.8 | 27.6 |
| 8000 w/surf. - 0.4% | 23.9 | 23.9 | 8000 w/surf. w/CC- 0.8% | 30.9 | 29.7 |
| 12000 w/surf. - 0.2% | 27.6 | 28.4 | 12000 w/surf. w/CC- 0.6% | 32.5 | 31.7 |
| 12000 w/surf. - 0.3% | 21.8 | 23.5 | 12000 w/surf. w/CC- 0.7% | 27.1 | 28.5 |
| 12000 w/surf. - 0.4% | 21.2 | 22.4 | 12000 w/surf. w/CC- 0.8% | 27.1 | 28.0 |

[ME]: Concentration of Mobility Enhancing Composition in Spray Bath.
Mobility Enhancing Compositions*: Were applied at varied concentration, PEG MW and Surfactant presence.

Slip angle test results for PEG in combination with a surfactant component as a mobility enhancer on bare metal are shown graphically in FIG. 1B, with x-axis designations indicating: “molecular weight of PEG-presence or absence of surfactant-concentration of mobility enhancing composition tested. For example, “200 w/surf.-0.2%” indicates a mobility enhancing composition working concentration of 0.2 wt. % containing PEG MW 200, with the surfactant component shown in Table 2.

FIG. 2B graphically depicts slip angle test results for a mobility enhancer including PEG and a surfactant component (labeled “w/surf.”) on conversion coated metal, with similar x-axis designations indicating: molecular weight of PEG-presence/absence of surfactant-concentration of mobility enhancer tested, e.g. “200 w/surf. w/CC-0.6%”, identifying a mobility enhancer applied at a working concentration of 0.6 wt. % containing PEG MW 200 and a surfactant component onto a conversion coated metal substrate.

Surprisingly, the slip angle results for the mobility enhancing compositions of Table 2, that contain a surfactant component showed improved results on conversion coated metal cans in addition to bare clean metal cans. FIG. 1A shows that slip angle is affected significantly by the MW of the PEG used and also affected by the concentration of the mobility enhancing composition in the working spray bath. Mobility enhancers containing a surfactant component and PEG of MW 600 or greater all showed average slip angles in the desired range of less than 35°, see FIG. 1B. A majority of these mobility enhancers with surfactant component had average slip angles of less than 30°.

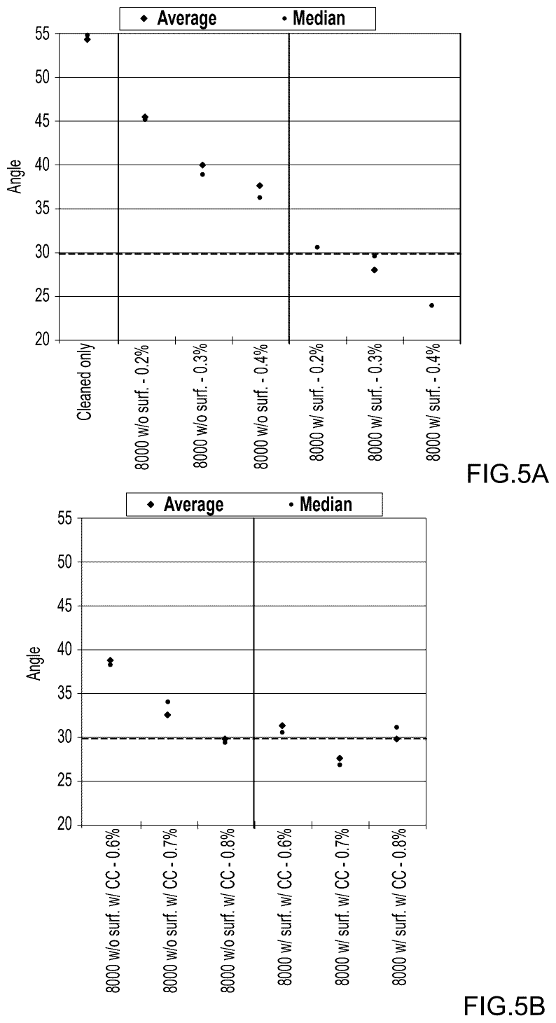

Conversion coated cans treated with mobility enhancing compositions of Table 2, which contain a surfactant component also showed improved results on conversion coated metal cans, see Table 3 and FIGS. 5A & 5B. Mobility enhancers containing a surfactant component and PEG of MW 600 or greater all showed average slip angles in the desired range of less than 35°. A combination of higher MW and higher concentration of mobility enhancing composition in the working spray bath produced average slip angles of less than 30° in a majority of these mobility enhancers with surfactant component.

### Example 4-Comparative Slip Angle Performance Testing

Testing was performed on conversion coated cans by applying and drying-in-place various concentrations of three different mobility enhancing compositions. Example 1 was a mobility enhancing composition comprising PEG MW 8000 and a surfactant component of Surfactants A & E according to the invention.

Comp. Ex. 10 mobility enhancing composition contained Surfactant B, and Comp. Ex. 20 was a mobility enhancing composition containing a combination of an oleyl alcohol ethoxylate-non-ionic surfactant, a non-ionic surfactant described as ethoxylated propoxylated C12-14 alcohol, phosphoric acid, and a sulfosuccinate-based anionic surfactant. Both are benchmark aqueous mobility enhancing compositions, which contain no PEG.

Various concentrations of each mobility enhancing composition were made according to the Table below and each concentration is identified by a digital suffix, e.g. Comp. Ex. 10 at concentration of 0.3 wt. % has the designation “10.3”. Each mobility enhancing composition was applied and dried-in-place on conversion coated aluminum cans and the cans' slip angles tested, see Table 4.

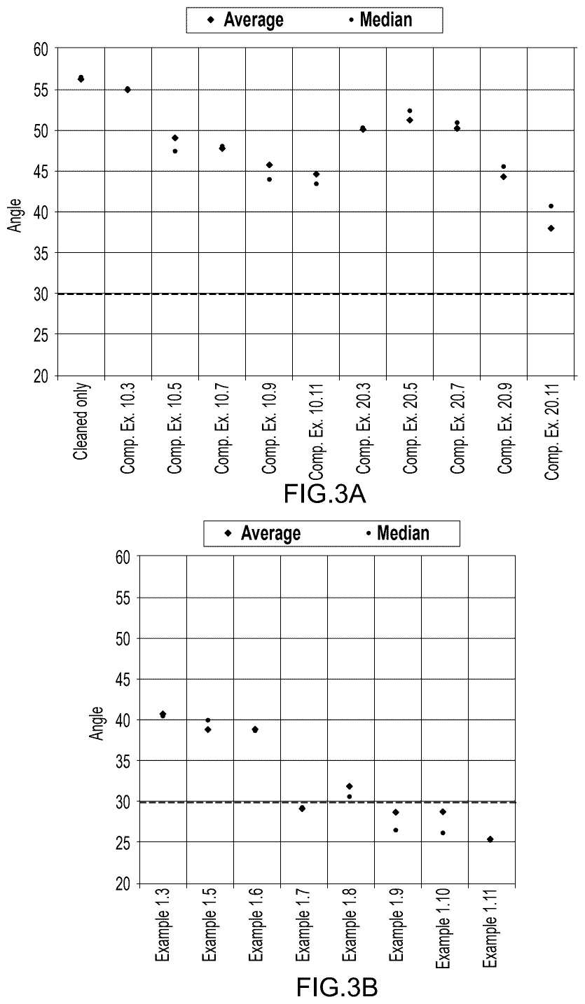

FIGS. 3A & 3B provide a graphic depiction of the results of the slip angle performance on conversion coated cans comparing various concentrations of Comp. Ex. 10 and Comp. Ex. 20, (see FIG. 3A) and mobility enhancing compositions according to the invention (“Example 1”), (see FIG. 3B) with respect to slip angle as a function of concentration. FIG. 3B test results show that Example 1 of the inventive composition produced improved results in the form of much reduced slip angle at all concentrations tested. and slip angles of less than 35° at 0.7 wt. % (Example 1.7) and less than 30° slip angle at 0.9 wt. % to 0.11 wt. % of mobility enhancing compositions of the invention, see Examples 1.9, 1.10 and 1.11). This is a significant performance benefit in reducing the coefficient of friction on conversion coated cans.

TABLE 4
Slip Angle: Comparative Examples and Inventive Example Mobility Enhancing
Compositions in Varied Concentrations* on Conversion Coated Cans

| Comp. Ex. 10 | | | Comp. Ex. 20 | Median | Average | Example 1 | Median | Average |
|---|---|---|---|---|---|---|---|---|
| in varied | Median | Average | in varied | Slip | Slip | in varied | Slip | Slip |
| [ME] | Slip Angle | Slip Angle | [ME] | Angle | Angle | [ME] | Angle | Angle |
| Cleaned only | 56.8 | 55.9 | | | | | | |
| Comp. Ex. | 55.3 | 54.8 | Comp. Ex. | 50.2 | 50.3 | Example | 40.8 | 41.1 |
| 10.3 | | | 20.3 | | | 1.3 | | |
| Comp. Ex. | 47.5 | 49.1 | Comp. Ex. | 52.4 | 51.3 | Example | 40.3 | 39.1 |
| 10.5 | | | 20.5 | | | 1.5 | | |
| | | | | | | Example | 38.8 | 38.8 |
| | | | | | | 1.6 | | |
| Comp. Ex. | 48.1 | 47.7 | Comp. Ex. | 51.0 | 50.2 | Example | 29.2 | 29.0 |
| 10.7 | | | 20.7 | | | 1.7 | | |
| | | | | | | Example | 30.5 | 31.8 |
| | | | | | | 1.8 | | |
| Comp. Ex. | 44.0 | 45.9 | Comp. Ex. | 45.6 | 44.4 | Example | 26.4 | 28.6 |
| 10.9 | | | 20.9 | | | 1.9 | | |
| | | | | | | Example | 26.0 | 28.6 |
| | | | | | | 1.10 | | |
| Comp. Ex. | 43.5 | 44.7 | Comp. Ex. | 40.8 | 38.0 | Example | 25.2 | 25.5 |
| 10.11 | | | 20.11 | | | 1.11 | | |

*Concentration of ME composition in the working bath is indicated by the decimal suffix of the example number in weight %.

As shown in FIGS. 3A & 3B, a comparison of Example 1, Comparative Example 10 and Comparative Example 20, in various concentrations applied and dried in place on conversion coated metal cans, indicated that the inventive composition (Example 1) was also able to improve slip angle when applied to a metal surface bearing a conversion coating, see FIG. 3B, as compared to the Comparative Examples, see FIG. 3A.

### Example 5: Foam Volume and Persistence Testing

As discussed above, a drawback of some mobility enhancing compositions is excess foam generation. Results of high volume and/or persistent foam in a mobility enhancing composition include foam overflow from the bath or sump as well as subsequent drag-out of material from the processing line and into the oven.

A further benefit of the present composition is the reduction in foam as compared with benchmark aqueous mobility enhancing compositions made in the absence of PEG. Foam height and persistence were measured for Example 1, Comparative Ex. 10, and Comparative Ex. 20, each at mobility enhancing composition concentration of 0.7 wt. %. Analysis was conducted using a commercially available CNOMO Foaming Test Apparatus, according to procedures available from the manufacturer. Products may also be compared using the ASTM D892 Foam Test, which is used to determine the foaming tendency and stability of foam in lubricating oils at 24°° C. The mobility enhancing compositions of the examples were each separately tested using a pump to circulate 30 deg. C. liquid samples at a controlled and constant flow rate of 125 liters/hour through a calibrated ferrule at a specific height in a graduated glass cylinder for a selected aeriation period. Foam volume at 10 minutes for both comparative examples was 2000 ml, compared to 1280 ml for Example 1. Comparative Ex. 10 took only 3.0 minutes to foam to 2000 ml, and Comparative Ex. 20 took less time, only 2.5 minutes to reach 2000 ml.

At the end of the aeriation period, foam decay height (liquid+foam) and persistent foam were measured at 2 min. intervals to determine foaming tendency and persistence of foam, see Table 5 below.

TABLE 5
Foam decay measurement

| | | | | | | | |
|---|---|---|---|---|---|---|---|
| 0 | 2 | 4 | 6 | 8 | 10 | 12 | 14 |
| min. | min. | min. | min. | min. | min. | min. | min. |

Foam Decay ml (Liquid + Foam)

| | | | | | | | |
|---|---|---|---|---|---|---|---|
| Comp. | 2000 | 2000 | 1900 | 1840 | 1800 | 1740 | 1680 |
| Ex. 10 | | | | | | | |
| Comp. | 1840 | 1600 | 1300 | 1060 | 1000 | 1000 | 990 |
| Ex. 20 | | | | | | | |
| Ex. 1 | 1040 | 1020 | 1000 | 1000 | 1000 | 1000 | 990 |

Persistent Foam ml

| | | | | | | | | |
|---|---|---|---|---|---|---|---|---|
| Comp. | 1000 | 1000 | 1000 | 900 | 840 | 800 | 740 | 680 |
| Ex. 10 | | | | | | | | |
| Comp. | 1000 | 840 | 600 | 300 | 60 | 0 | 0 | 0 |
| Ex. 20 | | | | | | | | |
| Ex. 1 | 280 | 40 | 20 | 0 | 0 | 0 | 0 | 0 |

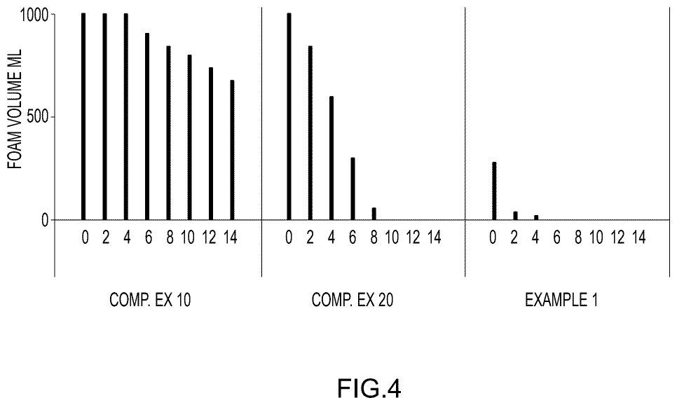

This persistent foaming test result is illustrated graphically in FIG. 4, which shows that the inventive composition exhibited less than ⅓ of the initial foam height of the comparative examples and dissipated much faster, dropping to zero by 8 minutes, compared to significant foam heights persisting past 8 minutes. This is telling since the persistence of the foam increases the tendency of foam to overflow.

### Example 6: Adhesion Testing-Comparative Examples and Inventive Example Mobility Enhancers

Adequate adhesion to the surface of the metal container represents an important requirement for mobility enhancing compositions and lacquers that may be used with them. Typically, lacquer does not come into contact with mobility enhancer material, other than minor amounts which may persist after the cure stage for the lacquer. However, adhesion of the layer of mobility enhancer after the aqueous mobility enhancing composition has dried in place was tested to determine whether an effective amount would remain to reduce the number of printer trips or times that a container does not easily and cleanly come off a mandrel used during the coating process.

Each aluminum test can was conversion coated on the surface, and subjected to different mobility enhancing composition type and concentration. Test can samples were each lacquered using conventional spray techniques and equipment depositing either an epoxy or a BPANI coating on the interior of the cans and cured for further adhesion testing. In the following table, the can test samples were assigned numbers according to the mobility enhancing composition used and its concentration.

The coated samples were cut down and exposed to a retort or a boil containing specific chemistries (citric acid, MSE, water, Dowfax and the like.) that are used as simulants to attack the coating and underlying metal simulating food and beverage effects on coatings. The tests used have been well-accepted in the industry, where a specific ASTM standard does not currently exist.

Test Methodology. The samples were suspended with a wire with spacers therebetween and each sample was immersed in one of the various aqueous test environments listed below (See, Test 1-6). Once removed from the respective test solution, each sample was rinsed with DI water and blot-dried with lint-free tissues followed by blushing testing and crosshatch testing.
1. MSE Solution: Test samples were submerged for 15 minutes, in 100° C. liquid composition containing a solution of 4% (v/v) acetic acid, 6% (v/v) lactic acid, and 6% (w/v) NaCl.
2. “Coke Acetic Acid” Test: Metal test samples were submerged for 30 minutes, in boiling liquid composition of 3% (v/v) acetic acid solution.
3. Dowfax™ Test: Test samples were submerged for 15 minutes, in boiling aqueous solution of 0.17% (v/v) of Dowfax™ 2A1 surfactant.
4. Hot Water Test: Test samples were submerged for 30 minutes, in 65° C. DI water.
5. Water Retort: Test samples were submerged in DI water in a sealed jar (e.g., autoclave) and held at 121° C., at 15 psi for either 30 minutes or 90 minutes, then cooled rapidly.
6. Acid Retort: Test samples were submerged in 1 or 2% (w/v) citric acid solution in a sealed jar and held at 121° C., 15 psi for 30 minutes, then cooled rapidly.

Blushing was determined by visually evaluating coated samples for haziness when removed from the test solution. A scale from 0 to 10 was used for recording the results: 0=severe blush, 5=moderately blush, 10=no blush-sample is as shiny as the untested sample.

Crosshatch test. The crosshatch test provides a measure of the ability of a coating to adhere to a surface, and is performed as follows: a crosshatched area is formed by making two perpendicular cuts on a coated sample using Elcometer 107 (11 knife edges spaced 1.5 mm apart). Firmly apply 3M scotch #610 tape to the crosshatched area and remove the tape. Examine the crosshatched area and report a number rating related to the percentage of coating remaining. The scale from 0 to 5 is used for recording the results. 0=complete removal of coating in the crosshatched region, 1=35-65% area removed in the crosshatched region, 2=15-35% area removed in the crosshatched region, 3=5-15% area removed in the crosshatched region, 4=<5% area removed in the crosshatched region, and 5=no adhesion loss in the crosshatched region.

In each case, after the cut down samples were exposed to the heated test environment, two tests were performed on the samples: adhesion blush and crosshatch tape pull. These tests provide insight into how the lacquer adheres to the surface of the can by use of a grid-like scoring of the lacquer surface, followed by adhesion of a tape to the surface, and pulling removal of the tape. If scored lacquer was removed by the tape pull, the lacquer exhibits adhesion failure. The test samples shown in Table 6, below, passed the tape pull adhesion test. A blushing level of 1 or 2 is considered acceptable by customers because it is mostly an aesthetic issue rather than a performance-related issue, but higher scores of 5 or 10 in the blush test indicate less blush and haziness which is preferred, see test results in Table 6 below.

TABLE 6
Adhesion Test Results for Comparative and Inventive Mobility Enhancers

| | | | Comp. | Comp. | Comp. | Comp. | | |
|---|---|---|---|---|---|---|---|---|
| | | | Ex. | Ex. | Ex. | Ex. | Ex. | Ex. |
| | | Control | 10.7 | 10.11 | 20.7 | 20.11 | 1.7 | 1.11 |
| | | Conversion Coating | | | | | | |
| | | | Conv. | Conv. | Conv. | Conv. | Conv. | Conv. |
| | | | Coating | Coating | Coating | Coating | Coating | Coating |
| | | Final Rinse | | | | | | |
| | | Cleaned | Comp. | Comp. | Comp. | Comp. | Example | Example |
| | | only | Ex. 10 | Ex. 10 | Ex. 20 | Ex. 20 | 1 | 1 |
| | | Final Rinse Concentration of ME (wt. %) | | | | | | |
| | | | 0.7 | 1.1 | 0.7 | 1.1 | 0.7 | 1.1 |
| 2% | Epoxy | P | P | P | P | P | P | P |
| Citric | Adhesion | | | | | | | |
| Acid - Retort | Epoxy | 1 | 0 | 2 | 0 | 1 | 1 | 1 |
| | Blush | | | | | | | |
| | (0-4) | | | | | | | |
| | BPNI | P | P | P | P | P | P | P |
| | Lacquer | | | | | | | |
| | Adhesion | | | | | | | |
| | BPNI | 0 | 1 | 1 | 1 | 2 | 1 | 0 |
| | Lacquer | | | | | | | |
| | Blush | | | | | | | |
| | (0-4) | | | | | | | |
| Acetic | Epoxy | P | P | P | P | P | P | P |
| acid | Lacquer | | | | | | | |
| boil | Adhesion | | | | | | | |
| 3% - 30 min | Epoxy | 0 | 3 | 3 | 2 | 2 | 4 | 4 |
| | Lacquer | | | | | | | |
| | Blush | | | | | | | |
| | (0-4) | | | | | | | |
| | BPNI | P | P | P | P | P | P | P |
| | Lacquer | | | | | | | |
| | Adhesion | | | | | | | |
| | BPNI | 0 | 1 | 1 | 0 | 0 | 3 | 2 |
| | Lacquer | | | | | | | |
| | Blush | | | | | | | |
| | (0-4) | | | | | | | |
| MSE | Epoxy | F | P | P | P | P | P | F |
| Boil - 15 min. | Lacquer | | | | | | | |
| | Adhesion | | | | | | | |
| | Epoxy | 0 | 0 | 1 | 2 | 2 | 0 | 1 |
| | Lacquer | | | | | | | |
| | Blush | | | | | | | |
| | (0-4) | | | | | | | |
| | BPNI | P | P | P | P | P | P | P |
| | Lacquer | | | | | | | |
| | Adhesion | | | | | | | |
| | BPNI | 0 | 2 | 1 | 1 | 2 | 1 | 0 |
| | Lacquer | | | | | | | |
| | Blush | | | | | | | |
| | (0-4) | | | | | | | |
| Water - Retort | Epoxy | P | P | P | P | P | P | P |
| | Lacquer | | | | | | | |
| | Adhesion | | | | | | | |
| | Epoxy | 1 | 0 | 0 | 0 | 0 | 0 | 0 |
| | Lacquer | | | | | | | |
| | Blush | | | | | | | |
| | (0-4) | | | | | | | |
| | BPNI | P | P | P | P | P | P | P |
| | Lacquer | | | | | | | |
| | Adhesion | | | | | | | |
| | BPNI | 0 | 0 | 0 | 0 | 0 | 0 | 0 |
| | Lacquer | | | | | | | |
| | Blush | | | | | | | |
| | (0-4) | | | | | | | |
| 0.17% | Epoxy | P | P | P | P | P | P | P |
| Dowfax | Lacquer | | | | | | | |
| 2A1 | Adhesion | | | | | | | |
| Boil - 15 min. | Epoxy | 1 | 0 | 0 | 0 | 1 | 1 | 0 |
| | Lacquer | | | | | | | |
| | Blush | | | | | | | |
| | (0-4) | | | | | | | |
| | BPNI | P | P | P | P | P | P | P |
| | Lacquer | | | | | | | |
| | Adhesion | | | | | | | |
| | BPNI | 0 | 1 | 0 | 0 | 0 | 0 | 0 |
| | Lacquer | | | | | | | |
| | Blush | | | | | | | |
| | (0-4) | | | | | | | |

“P” = Pass and “F” = Fail

The skilled artisan will understand that the foregoing Examples are merely embodiments illustrating the inventions components and performance. They are in no way intended to limit the invention to the exemplary embodiments.

What is claimed:

1. An aqueous mobility enhancing composition for improving travel of metal containers through a manufacturing process, the composition comprising:
polyethylene glycol (PEG) having a molecular weight of about 200 to about 15,000 Dalton;
a surfactant component; and
optionally, a biocidal agent.

2. The aqueous mobility enhancing composition according to claim 1, wherein the PEG has a molecular weight of about 5,000 to about 10,000 Dalton.

3. The aqueous mobility enhancing composition according to claim 1, wherein the PEG has a molecular weight of about 7,000 to about 9,000 Dalton.

4. The aqueous mobility enhancing composition according to claim 1, wherein the PEG is present in an amount of about 1,500 ppm up to the solubility limit of the PEG in the composition.

5. The aqueous mobility enhancing composition according to claim 1, wherein the PEG is present in an amount of about 1,500 ppm up to about 8,000 ppm.

6. The aqueous mobility enhancing composition according to claim 1, wherein the PEG is present in an amount of about 1,500 ppm up to about 6,000 ppm.

7. The aqueous mobility enhancing composition according to claim 1, wherein the surfactant component comprises:
a first ethylene glycol-polyalkylene oxide copolymer present in an amount of about 15 ppm up to the solubility limit of the first ethylene glycol-polyalkylene oxide copolymer in the composition; and
a second ethylene glycol-polyalkylene oxide copolymer different from the first ethylene glycol polyalkylene oxide copolymer present in an amount of about 1 ppm up to the solubility limit of the second ethylene glycol-polyalkylene oxide copolymer in the composition;
wherein the PEG is present in an amount of about 1,500 ppm up to 5,000 ppm.

8. The aqueous mobility enhancing composition according to claim 7 wherein the first ethylene glycol-polyalkylene oxide copolymer comprises a copolymer of propylene oxide and ethylene oxide, optionally being a random copolymer, a block copolymer, an ethylene oxide end-capped copolymer or a combination thereof.

9. The aqueous mobility enhancing composition according to claim 7 wherein the first ethylene glycol-polyalkylene oxide copolymer comprises a triblock copolymer of polyethylene oxide, polypropylene oxide, and polyethylene oxide; and has a molecular weight of about 5,000 to 10,000 Dalton.

10. The aqueous mobility enhancing composition according to claim 9, wherein the first ethylene glycol-polyalkylene oxide copolymer is present in an amount of about 14 ppm up to the solubility limit of the first ethylene glycol-polyalkylene oxide copolymer in the composition.

11. The aqueous mobility enhancing composition according to claim 10, wherein the first ethylene glycol-polyalkylene oxide copolymer is present in an amount of about 14 ppm to about 100 ppm.

12. The aqueous mobility enhancing composition according to claim 11, wherein the second ethylene glycol-polyalkylene oxide copolymer comprises a copolymer of propylene oxide and ethylene oxide, optionally being a random copolymer, a block copolymer, an ethylene oxide end-capped copolymer or a combination thereof and has a molecular weight of about 1,500 to 3,500 Dalton.

13. The aqueous mobility enhancing composition according to claim 7 wherein the second ethylene glycol-polyalkylene oxide copolymer comprises a difunctional block copolymer surfactant comprising about 10 to 30 wt. % ethylene oxide and terminating in primary hydroxyl groups.

14. The aqueous mobility enhancing composition according to claim 13, wherein the second ethylene glycol-polyalkylene oxide copolymer is present in an amount of about 1 ppm up to the solubility limit of the second ethylene glycol-polyalkylene oxide copolymer in the composition.

15. The aqueous mobility enhancing composition according to claim 13, wherein the second ethylene glycol-polyethylene oxide copolymer is present in an amount of about 1 ppm up to about 30 ppm.

16. The aqueous mobility enhancing composition according to claim 13, wherein the ratio of the first and second ethylene glycol-polyalkylene oxide copolymers is in a range of about 2:1 to about 0.75:1, optionally about 1.5:1 to 1:1.

17. The aqueous mobility enhancing composition according to claim 1, wherein the biocidal agent comprises 2-Methyl-4-isothiazolin-3-one.

18. A concentrate useful in forming an aqueous mobility enhancing composition by dilution with water, the concentrate comprising: polyethylene glycol (PEG) having a molecular weight of about 200 to about 15,000 Dalton; a surfactant; and a biocidal agent.

19. The concentrate according to claim 18, wherein total surfactant is present in a ratio to total PEG ranging from 5 pbw:100 pbw to 15 pbw:100 pbw.

20. A method of making an aqueous mobility enhancing composition for reducing a coefficient of friction of a surface of a metal container comprising mixing the concentrate according to claim 18 with an aqueous diluent.

21. The method according to claim 20, wherein mixing the concentrate comprises adding the concentrate to an aqueous bath in an amount of about 2 g to 7 g per liter of the aqueous bath.

22. A method for reducing a coefficient of friction of a surface of a metal container, the method comprising: contacting the surface of the metal container with an aqueous mobility enhancing composition according to claim 1; and drying the composition in place.

23. The method according to claim 22, further comprising applying a conversion coating to the surface of the metal container prior to contacting the metal container in the aqueous mobility enhancing composition.

24. The method according to claim 22, wherein the surface of the metal container has a slip angle of 30° or lower after drying.

25. A metal container comprising a surface bearing an aqueous mobility enhancing composition according to claim 1.

26. The metal container according to claim 25, wherein the surface of the metal container has a slip angle of 30° or lower.

27. A metal container comprising a surface having a coefficient of friction that has been reduced using the method according to claim 22.

28. The metal container according to claim 27, wherein the surface of the metal container has a slip angle of 30° or lower following the contacting step.

29. A method for processing a metal container comprising guiding the metal container through a manufacturing process, wherein the metal container comprises a surface that has been contacted with an aqueous mobility enhancing composition according to claim 1.

30. A method for processing a metal container comprising guiding the metal container through a manufacturing process, wherein the metal container comprises a surface having a coefficient of friction that has been reduced using the method according to claim 22.

31. A coating on a metal surface comprising a mobility enhancer that is formed by contacting the metal surface with an aqueous mobility enhancing composition according to claim 1 and drying the composition on the metal surface.

32. The coating according to claim 31, further comprising a conversion coating layer interposed between the metal surface and the mobility enhancer.
